(19) United States
(12) Patent Application Publication
(10) Pub. No.: US 2024/0020328 A1
(43) Pub. Date: Jan. 18, 2024

(54) SYSTEMS AND METHODS FOR INTELLIGENT DOCUMENT VERIFICATION

(71) Applicant: Dell Products L.P., Round Rock, TX (US)

(72) Inventors: Subhashini Puram, Hyderabad (IN); Sanjukta De, Gurgaon (IN); Shibi Panikkar, Bangalore (IN); Aashna Mohapatra, Bhubaneswar (IN)

(73) Assignee: Dell Products L.P., Round Rock, TX (US)

(21) Appl. No.: 17/813,163

(22) Filed: Jul. 18, 2022

(51) Int. Cl. G06F 16/35

(52) U.S. Cl. CPC G06F 16/353

(57) ABSTRACT

In one aspect, an example methodology implementing the disclosed techniques includes, by a document verification service, a reference text combination of a document to verify and determining, using a first classification model, a type of the document based on the reference text combination of the document. The method also includes, by the document verification service, determining, using a second classification model, a source of the document based on the reference text combination of the document, and determining a template for the type of the document and the source of the document, the template indicating positioning of target data in documents of the type and source as the document. The method further includes, by the document verification service, one or more target data from the document using the template and the one or more target data extracted from the document.

### BACKGROUND

Organizations, such as companies, enterprises, and manufacturers, continually grapple with having to deal with increasing numbers of documents. For example, an organization that manufactures products typically process large numbers of many types of documents such as invoices, purchase orders, receipts, shipping orders, advance shipping notifications, export documents, and various forms. Many of these documents may be in electronic format such as Portable Document Format (PDF) and scanned images. The ability to extract data from these electronic documents is useful in a variety of contexts and applications, such as document verification.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

In accordance with one illustrative embodiment provided to illustrate the broader concepts, systems, and techniques described herein, a method includes, by a document verification service, a reference text combination of a document to verify and determining, using a first classification model, a type of the document based on the reference text combination of the document. The method also includes, by the document verification service, determining, using a second classification model, a source of the document based on the reference text combination of the document, and determining a template for the type of the document and the source of the document, the template indicating positioning of target data in documents of the type and source as the document. The method further includes, by the document verification service, one or more target data from the document using the template and the one or more target data extracted from the document.

In some embodiments, the reference text combination is in a portion of the document.

In some embodiments, the reference text combination is determined from text extracted from a portion of the document.

In some embodiments, verifying the one or more target data includes comparing one of the one or more target data to valid data.

In some embodiments, the first classification model includes a multiclass support vector machine.

In some embodiments, the first classification model is trained using supervised learning with reference text combinations extracted from a portion of each document of a plurality of historical documents.

In some embodiments, the second classification model includes a k-nearest neighbor (k-NN) classifier. In some embodiments, the k-NN classifier determines the source of the document based on distance measures of the reference text combination of the document and reference text combinations of a plurality of historical documents of the type as the document

In some embodiments, the template is generated utilizing the first classification model and the second classification model.

According to another illustrative embodiment provided to illustrate the broader concepts described herein, a system includes one or more non-transitory machine-readable mediums configured to store instructions and one or more processors configured to execute the instructions stored on the one or more non-transitory machine-readable mediums. Execution of the instructions causes the one or more processors to carry out a process corresponding to the aforementioned method or any described embodiment thereof.

According to another illustrative embodiment provided to illustrate the broader concepts described herein, a non-transitory machine-readable medium encodes instructions that when executed by one or more processors cause a process to be carried out, the process corresponding to the aforementioned method or any described embodiment thereof.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1A is a block diagram of an illustrative network environment for intelligent document verification, in accordance with an embodiment of the present disclosure.

FIG. 1B is a block diagram of an illustrative document verification service, in accordance with an embodiment of the present disclosure.

FIG. 2 is a flow diagram of an example process for generating templates for extracting target data from documents, in accordance with an embodiment of the present disclosure.

FIG. 3 is a flow diagram of an example process for verifying a document, in accordance with an embodiment of the present disclosure.

FIG. 4 is a block diagram illustrating selective components of an example computing device in which various aspects of the disclosure may be implemented, in accordance with an embodiment of the present disclosure.

### DETAILED DESCRIPTION

The ability to automatically extract data from electronic documents is useful in contexts and applications such as, for example, document classification and verification. For example, organizations may extract data from electronic documents and verify the extracted data with values in a database(s). Unfortunately, organizations may find this challenging to implement. One approach involves extracting all the data from the different electronic documents, classifying the electronic documents based on the extracted data, and verifying the extracted data based on the classification. However, since the structure of each document can be different, and the data, such as text, within the documents is not known, the classification is based on unsupervised classification algorithms. Thus, minor variations in the structure and/or data within an electronic document can lead to an incorrect classification of the electronic document which, in turn, can result in an erroneous verification. Documents that are incorrectly classified may need to be reprocessed. Such effort can be time consuming for organizations and result in increased resource usage by computing devices used to extract all the data from the different electronic documents and classify electronic documents based on the extracted data.

Certain embodiments of the concepts, techniques, and structures disclosed herein are directed intelligent verification of documents. The verification of the documents is achieved by building and using multiple classification models to templatize the different types documents received from various sources, and verifying the documents based on data (or “target data”) extracted from the documents using the templates. The types of documents may include invoices, purchase orders, receipts, shipping orders, advance shipping notifications, export documents, and any other documents received by an organization. The sources (or “document sources”) may include suppliers, factories, original design manufacturers (ODMs), contract manufacturers, partners, vendors, financial institutions, government agencies, and other entity or organization that sends or otherwise provides a document to the organization. When a new document is received, the same classification models used in generating the templates can be used to determine a document type and a document source of the new document. Once the new document is classified into an appropriate document type and document source, a template which is appropriate for extracting target data from documents of the same document type and from the same document source as the new document can be determined (or “identified”) and used to extract the target data from the new document. The target data extracted from the new document can then be verified in order to verify the new document.

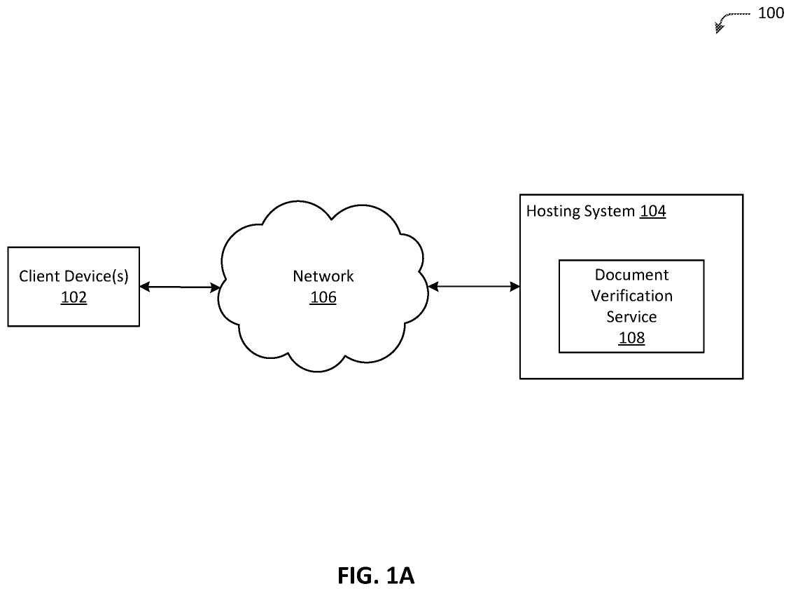

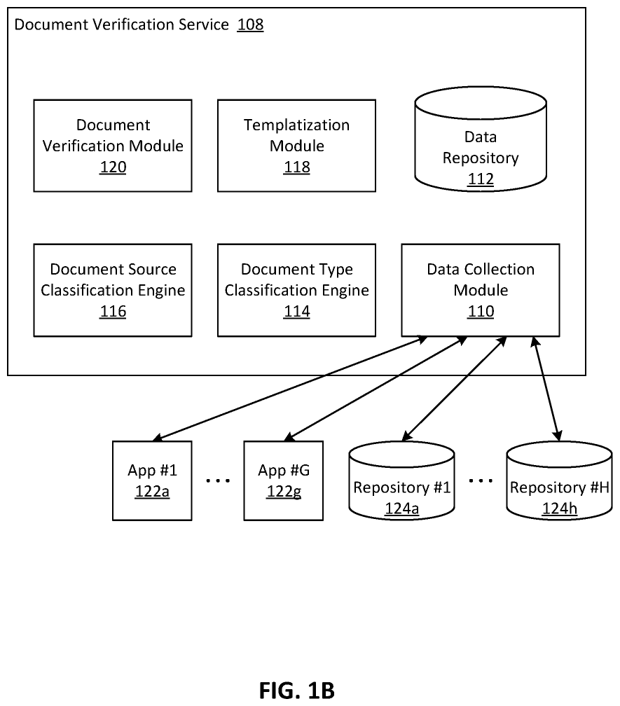

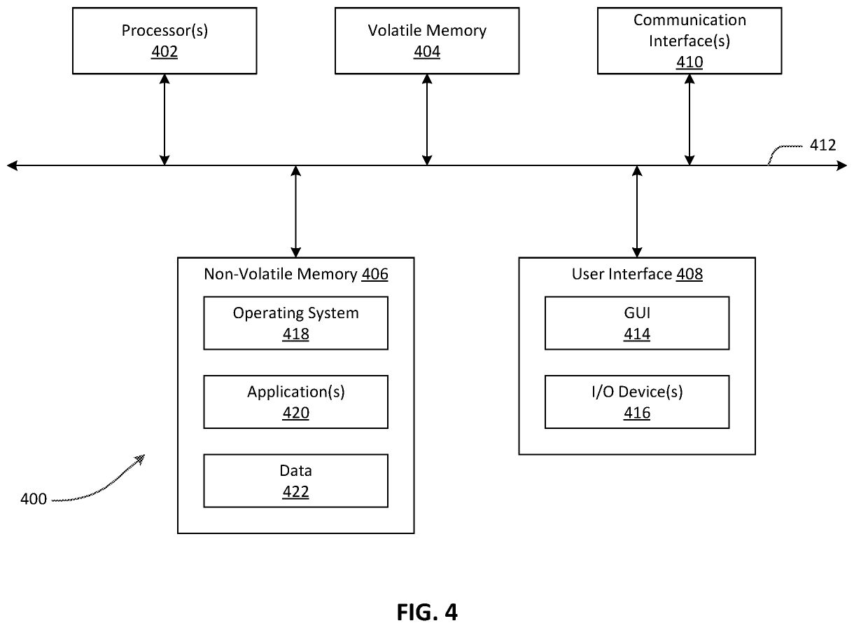

Turning now to the figures, FIG. 1A is a block diagram of an illustrative network environment 100 for intelligent document verification, in accordance with an embodiment of the present disclosure. As illustrated, network environment 100 may include one or more client devices 102 communicatively coupled to a hosting system 104 via a network 106. Client devices 102 can include smartphones, tablet computers, laptop computers, desktop computers, workstations, or other computing devices configured to run user applications (or “apps”). In some implementations, client devices 102 may be substantially similar to a computing device 400, which is further described below with respect to FIG. 4.

Hosting system 104 can include one or more computing devices that are configured to host and/or manage applications and/or services. Hosting system 104 may include load balancers, frontend servers, backend servers, authentication servers, and/or any other suitable type of computing device. For instance, hosting system 104 may include one or more computing devices that are substantially similar to computing device 400, which is further described below with respect to FIG. 4.

In some embodiments, hosting system 104 can be provided within a cloud computing environment, which may also be referred to as a cloud, cloud environment, cloud computing or cloud network. The cloud computing environment can provide the delivery of shared computing services (e.g., microservices) and/or resources to multiple users or tenants. For example, the shared resources and services can include, but are not limited to, networks, network bandwidth, servers, processing, memory, storage, applications, virtual machines, databases, software, hardware, analytics, and intelligence.

As shown in FIG. 1A, hosting system 104 may include a document verification service 108. As described in further detail at least with respect to FIGS. 1B-3, document verification service 108 is generally configured to provide intelligent verification of documents. The documents may include different types of documents that are received by an organization from various sources. Briefly, in one example use case, a user associated with the organization, such as an individual who needs to verify a document received and/or being processed by the organization, can use a client application, such as a web client, on their client device 102 to access and utilize document verification service 108. The client application and document verification service 108 can communicate using an application program interface (API). For example, the client application can send API requests (or “messages”) to document verification service 108 and document verification service 108 can send API responses/messages back to the client application. The client application may provide user interface (UI) controls (e.g., a button or other type of control) that enable the user to request verification of an electronic (e.g., scanned) document. In response to the user clicking, tapping, or otherwise interacting with such UI control, the client application can send a message to document verification service 108 requesting verification of the document. In response to such request being received, document verification service 108 can verify the document and send information indicative of the result of the verification to the client application in a response. In response to receiving the response, the client application can, for example, present the result of the verification to the user (e.g., present the result within a UI for viewing by the user). The user can then take appropriate action based on the result of the verification.

FIG. 1B is a block diagram of an illustrative document verification service 108, in accordance with an embodiment of the present disclosure. For example, an organization such as a company, an enterprise, or other entity that receives documents, such as supply chain or other business documents from its partners, for instance, may implement and use document verification service 108 to intelligently verify the documents. Document verification service 108 can be implemented as computer instructions executable to perform the corresponding functions disclosed herein. Document verification service 108 can be logically and/or physically organized into one or more components. The various components of document verification service 108 can communicate or otherwise interact utilizing APIs, such as, for example, a Representational State Transfer (RESTful) API, a Hypertext Transfer Protocol (HTTP) API, or another suitable API, including combinations thereof.

In the example of FIG. 1B, document verification service 108 includes a data collection module 110, a data repository 112, a document type classification engine 114, a document source classification engine 116, a templatization module 118, and a document verification module 120. Document verification service 108 can include various other components (e.g., software and/or hardware components) which, for the sake of clarity, are not shown in FIG. 1B. It is also appreciated that document verification service 108 may not include certain of the components depicted in FIG. 1B. For example, in certain embodiments, document verification service 108 may not include one or more of the components illustrated in FIG. 1B, such as, for example, data collection module 110 and/or templatization module 118, but document verification service 108 may connect or otherwise couple to the one or more components via a communication interface. Thus, it should be appreciated that numerous configurations of document verification service 108 can be implemented and the present disclosure is not intended to be limited to any particular one. That is, the degree of integration and distribution of the functional component(s) provided herein can vary greatly from one embodiment to the next, as will be appreciated in light of this disclosure.

Referring to document verification service 108, data collection module 110 is operable to collect or otherwise retrieve the organization's historical documents from one or more data sources. The data sources can include, for example, one or more applications 122a-122g (individually referred to herein as application 122 or collectively referred to herein as applications 122) and one or more repositories 124a-124h (individually referred to herein as repository 124 or collectively referred to herein as repositories 124). Applications 122 can include various types of applications such as software as a service (SaaS) applications, web applications, and desktop applications, among others. In some embodiments, applications 122 may correspond to the organization's enterprise applications such as supply chain management systems, order management systems, order fulfillment systems, and other enterprise systems which may be sources of the organization's historical documents. Repositories 124 can include various types of data repositories such as conventional file systems, cloud-based storage services such as SHAREFILE, BITBUCKET, DROPBOX, and MICROSOFT ONEDRIVE, and web servers that host files, documents, and other materials. In some embodiments, repositories 124 may correspond to the organization's repositories used for storing at least some of the historical documents.

Data collection module 110 can utilize application programming interfaces (APIs) provided by the various data sources to collect information and materials therefrom. For example, data collection module 110 can use a REST-based API or other suitable API provided by an enterprise application/system to collect information therefrom (e.g., to collect the historical documents). In the case of web-based applications, data collection module 110 can use a Web API provided by a web application to collect information therefrom. As another example, data collection module 110 can use a file system interface to retrieve the files containing historical documents from a file system. As yet another example, data collection module 110 can use an API to collect historical documents from a cloud-based storage service. A particular data source (e.g., an enterprise application/system and/or data source) can be hosted within a cloud computing environment (e.g., the cloud computing environment of document verification service 108 or a different cloud computing environment) or within an on-premises data center (e.g., an on-premises data center of an organization that utilizes document verification service 110).

In cases where an application or data repository does not provide an interface or API, other means, such as printing and/or imaging, may be utilized to collect information therefrom (e.g., generate an image of printed historical documents). Optical character recognition (OCR) technology can then be used to convert the image of the content to textual data.

As mentioned previously, data collection module 110 can collect or otherwise retrieve the organization's historical documents. The organization may receive many different types of documents, such as invoices and purchase orders, from various sources, such as partners, vendors, agencies, and other sources. The organization may store or otherwise maintain such historical documents in one or more applications 122 and/or repositories 124, as described previously.

In some embodiments, data collection module 110 can collect historical documents from one or more of the various data sources on a continuous or periodic basis (e.g., according to a predetermined schedule specified by the organization). Additionally or alternatively, data collection module 110 can collect historical documents from one or more of the various data sources in response to an input. For example, a user, such as a member of the organizations information technology (IT) team, can use their client device 102 to access document verification service 108 and issue a request to document verification service 108 that causes data collection module 110 to collect historical documents form one or more data sources. In some embodiments, data collection module 110 may collect the historical documents from the preceding two months, three months, or another suitable period. The time period from which to collect the historical documents may be configurable by the organization. In some embodiments, data collection module 110 can store the historical documents collected from the various data sources within data repository 112, where it can subsequently be retrieved and used. For example, as will be further described below, historical documents from data repository 112 can be retrieved and used to generate a training dataset for use in building a classification model of document type classification engine 114. In some embodiments, data repository 112 may correspond to a storage service within the computing environment of document verification service 108.

Document type classification engine 114 is operable to classify (or “categorize”) documents into their document types, such as invoice, purchase order, receipt, shipping order, advance shipping notification, and export document, among others (i.e., predict a type of document for a given document). In some embodiments, document type classification engine 114 can include a classification model, such as a multiclass support vector machine (SVM), to classify a document into one of three or more document types. The multiclass classification model may be trained using the organization's historical documents. The corpus of historical documents with which to train the classification model (e.g., the multiclass classification model) may be collected by data collection module 110, as previously described herein. In one embodiment, the organization's historical documents from at least the preceding two months may be used as the corpus of historical documents. The amount of historical documents to use in training the multiclass classification model may be configurable by the organization. In some embodiments, the amount of historical documents to use in training the multiclass classification model may be received by or otherwise provided to document type classification engine 114. For example, the amount of historical documents to use in training the multiclass classification model may be received with a request that causes document classification engine 114 to build the classification model.

Once the corpus of historical documents is retrieved, a training dataset for training the multiclass classification model (e.g., the multiclass SVM) may be generated by extracting text (e.g., textual data) from the historical documents. The text may be extracted from individual historical documents using, for example, optical character recognition (OCR), computer vision, and/or other visual recognition techniques suitable for extracting text from electronic documents. In one embodiment, the text may be extracted from a portion of each historical document (e.g., extracted from a header portion or the top portion of a first page of each historical document). The text extracted from each historical document may then be lemmatized utilizing Natural Language Understanding (NLU) or other suitable Natural Language Processing (NLP) techniques to determine the canonical or dictionary form of words in the extracted text. Other data processing, such as tokenization, noise removal, stopwords removal, and stemming may also be performed to place the text in a form that is suitable for use by the multiclass classification model.

The individual historical documents may include a known or an expected text combination (or “word combination”) which may indicate a document type for a document. In other words, the expected text combination or so-called keywords in a document may indicate a type of document. Such expected text combination is referred to herein as a “reference text combination.” For example, an invoice may include “invoice”, “invoice number”, “invoice ID”, “invoice date”, “bill from”, “bill to”, and combinations thereof, as the reference text combination. As another example, a purchase order may include “purchase”. “PO”, “purchase order”, “PO number”, “purchase order number”, and combinations thereof, as the reference text combination. As still another example, a receipt may include “receipt”, “receipt number”, “receipt date”, and combinations thereof, as the reference text combination. In any case, for a given document, the reference text combination in the document may be utilized to determine a type of document (i.e., determine a document type for the document). For the different types of documents, the reference text combination may be included in the text extracted from the individual historical documents (e.g., the reference text combination may be contained in the text extracted from a header section or a portion of a first page of the document).

The historical documents may be classified (or “categorized”) into document types based on the reference text combination within the lemmatized text of the historical documents. For example, if the lemmatized text of a historical document includes the reference text combination for an invoice (e.g., the lemmatized text includes “invoice”, “invoice number”, “invoice ID”, “invoice date”, “bill from”, and/or “bill to”), the historical document can be labeled or assigned a class label that identifies the historical document as belonging to the document type, invoice. As another example, if the lemmatized text of a historical document includes the reference text combination for a purchase order (e.g., the lemmatized text includes “purchase”. “PO”, “purchase order”, “PO number”, and/or “purchase order number”), the historical document can be labeled or assigned a class label that identifies the historical document as belonging to the document type, purchase order. The multiclass classification model may be trained on the labeled historical documents. In seeing the training dataset, the multiclass classification model learns patterns specific to each class, i.e., document types, and uses those patterns to predict the membership of future data (e.g., predict the membership of an unseen document). Once trained, the trained multiclass classification model may classify each of the historical documents into one of the document types. In seeing the training dataset, the multiclass classification model learns patterns specific to each class, i.e., document types, and uses those patterns to predict the membership of future data. In some embodiments, the trained multiclass classification model may be used to similarly classify a document, such as, for example, a new document received by the organization, into one of the document types represented in the training dataset.

Note that the use of text extracted from a portion of the documents to classify the documents into the different document types improves the efficiency of the document type classification since the text from the whole document need not be extracted. Further, the use of known or expected text combinations to classify the documents into different document types increases the accuracy of the document classification since supervised learning algorithms can be used in building the classification models as compared to use of unsupervised learning algorithms.

Document source classification engine 116 is operable to classify documents of a given document type into their document sources. A document source may correspond to a sender or provider of a document (e.g., a source from which a document was received). The organization has knowledge of the various sources of the different types of documents it receives. For example, invoices may be from source A, source B, source C, source D, source E, source F, and source G. As another example, purchase orders may be from source A, source F, source H, source I, source J, and source K. As still another example, shipping orders may be from source B, source D, source L, source M, and source N. In the above example, documents (e.g., the organization's historical documents) that are categorized as invoices may be classified as being from one of source A, source B, source C, source D, source E, source F, or source G. Similarly, documents that are categorized as purchase orders may be classified as being from one of source A, source F, source H, source I, source J, or source K, and documents that are categorized as shipping orders may be classified as being from one of source B, source D, source L, source M, or source N.

Note that classification of documents of a given document category into the different document sources is possible because documents of the same document type, such as invoices, from a first document source are expected to have a structure that is different than the same type of document from a second source. For example, invoices from source A are expected to have a structure that is different than invoices from source B, source D, source L, etc. As another example, purchase orders from source K are expected to have a structure that is different than purchase orders from source A, source F, source H, etc. In any case, the varying structures of the same type of documents from the different document sources allows for classification of the documents of the same document type into their document sources.

It is further appreciated that the structure of a document may be based on the positioning of the reference text combination within the document. For example, in the invoices from source A, the reference text combination, e.g., “invoice”, “invoice number”, and “bill from”, can be expected to be in the same or substantially similar position (or “location”) in each invoice. As another example, in the invoices from source B, the reference text combination, e.g., “invoice”, “invoice number”, and “bill from”, can be expected to be in the same or substantially similar position in each invoice. Moreover, the positioning of the reference text combination in the invoices from source A can be expected to be different than the positioning of the reference text combination in the invoices from source B, source F, source H, etc.

In some embodiments, document source classification engine 116 can leverage a classification model (e.g., k-nearest neighbor (k-NN) algorithm and a distance similarity measure algorithm (e.g., Euclidean distance)) to classify documents of a given document type into their document sources. The k-NN algorithm is referred to herein as a “k-NN classifier.” The k-NN classifier operates on the basic assumption that data points (e.g., reference text combinations) with similar classes (e.g., document sources) are closer to each other. In such embodiments, the k-NN classifier may be run on (e.g., applied to) the documents of the given document type and each of the documents classified into a document source based on computed similarity distance measures (e.g., Euclidean distance measures) between the reference text combinations of the documents. In some implementations, the value of k may be set to the number of sources for the for the particular document type (e.g., the number of sources for the particular category of documents). For example, if there are seven sources of shipping orders, a k-NN classifier for classifying shipping orders into their document sources may have a value of k set to seven. As another example, if there are twenty sources of invoices, a k-NN classifier for classifying invoices into their document sources may have a value of k set to twenty. In other implementations, the value of k may be varied to obtain improved accuracy of the k-NN classifier, and the value of k that gives the optimal performance chosen (e.g., select the value of k that gives the highest accuracy).

In some embodiments, document source classification engine 116 can use a k-NN classifier to classify the organization's historical documents of a particular document type into their document sources. For example, a k-NN classifier may be applied to the organization's historical invoices to classify the historical invoices into their document sources based on the Euclidean distance measures between the reference text combinations of the historical invoices (e.g., classify each historical invoice as being from source A, source B, source C, source D, source E, source F, or source G). As another example, a k-NN classifier may be applied to the organization's historical invoices to classify the historical purchase orders into their document sources based on the Euclidean distance measures between the reference text combinations of the historical purchase orders (e.g., classify each historical purchase order as being from source A, source F, source H, source I, source J, or source K).

In some embodiments, document source classification engine 116 can use a k-NN classifier to classify a document of a given document type into its document source. The document may be, for example, a new document received by the organization. Once a document type of the new document is determined, document source classification engine 116 can use a k-NN classifier to classify the new document of the determined document type into its document source. For example, if a new document is determined to be an invoice, a k-NN classifier may be applied to the new invoice and at least some of the organization's historical invoices to classify the new invoice into its document source based on the Euclidean distance measures between the reference text combinations of the new invoice and the historical invoices (e.g., classify the new invoice as being from source A, source B, source C, source D, source E, source F, or source G). As another example, if a new document is determined to be a shipping order, a k-NN classifier may be applied to the new shipping order and at least some of the organization's historical shipping orders to classify the new shipping order into its document source based on the Euclidean distance measures between the reference text combinations of the new shipping order and the historical shipping orders (e.g., classify the new shipping order as being from source B, source D, source L, source M, or source N).

Still referring to document verification service 108, templatization module 118 is operable to generate templates for extracting target data from the different types of documents received by the organization from the various document sources. As used herein, the term “target data” refers to data, such as the contents or information within a field(s) in a document, which is to be extracted from the document. For example, target data in an invoice may include an invoice number, a bill to address, and an invoice value. The target data in an invoice may also optionally include a sender of the invoice and/or an invoice date. As another example, target data in a receipt may include a receipt date, a price before taxes, a price after taxes, a customer name, and contact information. As still another example, target data in a shipping order may include an order number, a shipping address, a billing address, and item detail(s). The examples of target data are merely illustrative and may vary depending on the type of document.

In some embodiments, templatization module 118 may generate a template for each type of document from a different document source. For example, templatization module 118 may generate a first template for extracting target data from invoices from source A, a second template (i.e., a different template from the first template generated for invoices from source A) for extracting target data from invoices from source B, a third template (i.e., a different template from the first and second templates generated for invoices from source A or source B) for extracting target data from invoices from source C, and so on. In similar fashion, templatization module 118 may generate individual templates for extracting target data from purchase orders from the different purchase order sources, generate individual templates for extracting target data from receipts from the different receipt sources, generate individual templates for extracting target data from shipping orders from the different shipping order sources, and so on. A template generated for a particular document type and document source may indicate where to find target data within a document of the same document type from the same document source for extraction of the target data. In other words, a template generated for a particular document type and document source may indicate the positioning of the target data in documents of the same document type from the same document source.

In some embodiments, templatization module 118 may generate the templates using the organization's historical documents. For example, templatization module 118 may use the historical documents from the previous two months, three months, or another suitable period to generate the templates. The amount of historical documents to use to generate the templates may be configurable by the organization and/or a user (e.g., a user using or requesting templatization module 118 to generate the templates). In some such embodiments, templatization module 118 may utilize document type classification engine 114 and document source classification engine 116 to classify the historical documents into their document types and document sources. Once the historical documents are classified into their document types and document sources, templatization module 118 can scan, parse, or otherwise analyze each historical document to determine the locations of the target data. Templatization module 118 can then templatize the historical documents of a particular document type and a document source based on the determined locations of the target data in those historical documents to generate a template for the particular document type and document source. In some embodiments, templatization module 118 may store the generated templates within a repository, such as, for example, data repository 112, where they can subsequently be retrieved and used.

In some embodiments, templatization module 118 may calibrate the positioning of the target data in a template to account for slight variations in the location of the target data in the historical documents used to generate the template. For example, in the historical invoices from source A, there may be slight variations in the locations of the target data, e.g., invoice value, or a field containing the target data. For example, the location of the invoice value (or the field containing the invoice value) may be at a first location in a first historical invoice (e.g., defined by a first set of pixel coordinates in the first invoice) and at a second location that is different than the first location in a second historical invoice (e.g., defined by a second set of pixel coordinates in the second invoice which is different than the first set of pixel coordinates in the first invoice). The location of the invoice value in other historical invoices from source A may also vary. When generating a template for extracting target data from an invoice from source A, the positioning of the invoice value in the template may be calibrated to account for such variations in the location of the invoice value in the various historical invoices from source A. Calibrating the positioning of the target data in a template allows for improved quality and efficiency of identification of locations of the target data in a document and accurate extraction of the target data from the document using the template.

Document verification module 120 is operable to verify the organization's documents. In some embodiments, document verification module 120 can utilize the templates generated by templatization module 118 to verify the documents. For example, for a given document, document verification module 120 can identify a template that is appropriate for extracting target data from the document, extract the target data from the document using the template, and verify some or all the target data extracted from the document (e.g., compare some or all of the target data with known values to verify the extracted target data) to verify the document. For example, an invoice value extracted from an invoice (i.e., an invoice amount specified in the invoice) may be verified by comparing the invoice value with a known value (e.g., a value that is expected to be in the invoice) to verify that the invoice indicates or otherwise has the correct invoice value. The known value may be determined using an invoice number and/or an invoice sender extracted from the invoice. As another example, a sales order number extracted from a shipping document can be used to extract and verify other data in the document, such as an address, to make sure that the shipping document is meant for the right customer, as well as information specific to that customer, such as the payment terms and billing currency.

By way of an example use case and embodiment, document verification module 120 may receive a request to verify a document, such as a new document received by the organization. To verify the document, document verification module 120 may extract the text (e.g., textual data) from an electronic version of the document (e.g., extract the text from the electronic or scanned document). Document verification module 120 may then lemmatize the extracted text and analyze the lemmatized text to determine a reference text combination within the lemmatized text. Document verification module 120 may then determine a type of the document based on the determined reference text combination. For example, in one embodiment, document verification module 102 may utilize document type classification engine 114 to classify the document into its document type (e.g., determine a document type for the document). Once the document type is determined for the document (e.g., once the document is classified into a document type), document verification module 120 may determine a source of the document. For example, in one embodiment, document verification module 102 may utilize document source classification engine 116 to classify the document into its document source (e.g., determine a document source for the document). Once the document type and document source are determined for the document (e.g., once the document is classified into a document type and a document source), document verification module 120 may identify or otherwise determine the template generated for the same document type and document source as the document. Document verification module 120 may then use the identified template to extract the target data from the document and verify the extracted target data to verify the document.

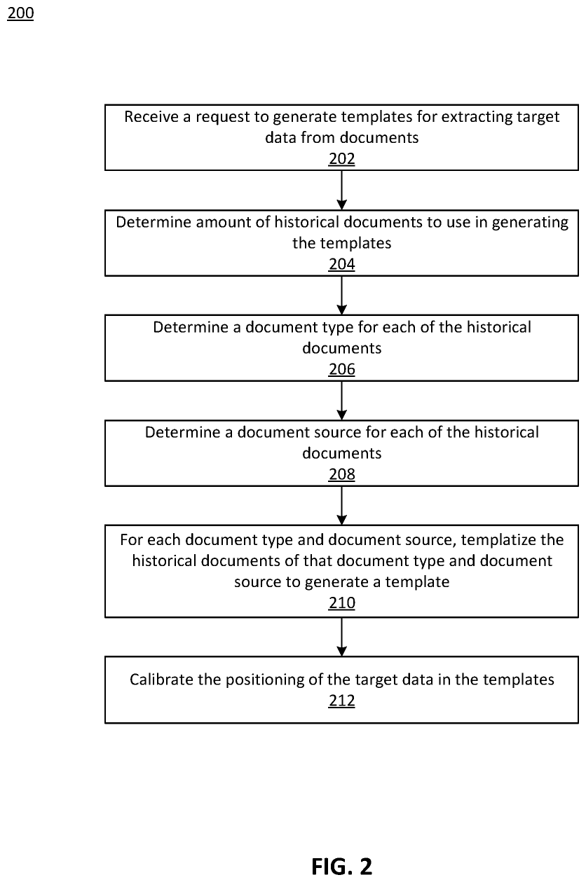

FIG. 2 is a flow diagram of an example process 200 for generating templates for extracting target data from documents, in accordance with an embodiment of the present disclosure. Process 200 may be implemented, for example, within templatization module 118 of FIG. 1B. In some embodiments, the templatization module may be part of a document verification service (e.g., document verification service 108 of FIG. 1B).

With reference to process 200 of FIG. 2, at 202, a request is received to generate templates for extracting target data from documents. The documents may be documents received by an organization (e.g., an organization's documents). The request can be received from a document verification service (e.g., document verification service 108 of FIG. 1B). For example, a user associated with an organization can use a client application on their client device (e.g., client device 102 of FIG. 1A) to send a message to the document verification service requesting the generation of the templates. In response to such request being received, the document verification service can send a request to the templatization module to generate the templates.

At 204, an amount of historical documents to use in generating the templates is determined. In some embodiments, the request to generate the templates can include an indication of the amount of historical documents to use in generating the templates. In other embodiments, the amount of historical documents to use may be specified in a configuration file accessible to the templatization module. For example, the organization may specify the amount of historical documents to use in the configuration file.

At 206, a document type is determined for each of the historical documents. In some embodiments, the templatization module can utilize a document type classification engine (e.g., document type classification engine 114 of FIG. 1B) to classify each historical document into its document type. For example, the document type classification engine can classify the historical documents into document types based on reference text combinations of the historical documents in the process of training (e.g., building) a multiclass classification model, as previously described herein. Determining a document type for each historical document allows for categorizing the historical documents into different types of documents.

At 208, a document source is determined for each of the historical documents. For example, the historical documents may first be categorized into their document types. Then, for each of the document types (e.g., for each type of document), a document source can be determined for each historical document of that document type (e.g., determined for each historical document categorized as that type of document). In some embodiments, the templatization module can utilize a document source classification engine (e.g., document source classification engine 116 of FIG. 1B) to classify the historical documents of a given document type into their document sources. For example, for historical documents of a given document type, the document source classification engine can classify the historical documents into their document sources based on reference text combinations of the historical documents by applying a k-NN classifier, as previously described herein. The templatization module may utilize the document source classification engine as needed to determine the document sources for the historical documents of the different document types. For example, suppose that the historical documents are of two document types, invoices and purchase orders. In this example, the templatization module may utilize the document source classification engine to classify the historical documents which are invoices into their document sources. The templatization module may utilize the document source classification engine again to classify the historical documents which are purchase orders into their document sources.

At 210, for each document type and document source, the historical documents of a given document type and document source are templatized to generate a template for extracting target data from documents of that document type and document source. For example, the historical documents of a given document type and document source can be scanned, parsed, or otherwise analyzed to determine the locations of the target data in each of the historical documents. The historical documents can then be templatized based on the determined locations of the target data in the historical documents of that document type and document source to generate the template.

At 212, the positioning of the target data in the templates are calibrated to account for slight variations in the location of the target data in the historical documents used to generate the templates. The calibrated templates can then use used to extract target data from documents, such as, for example, new documents received by the organization.

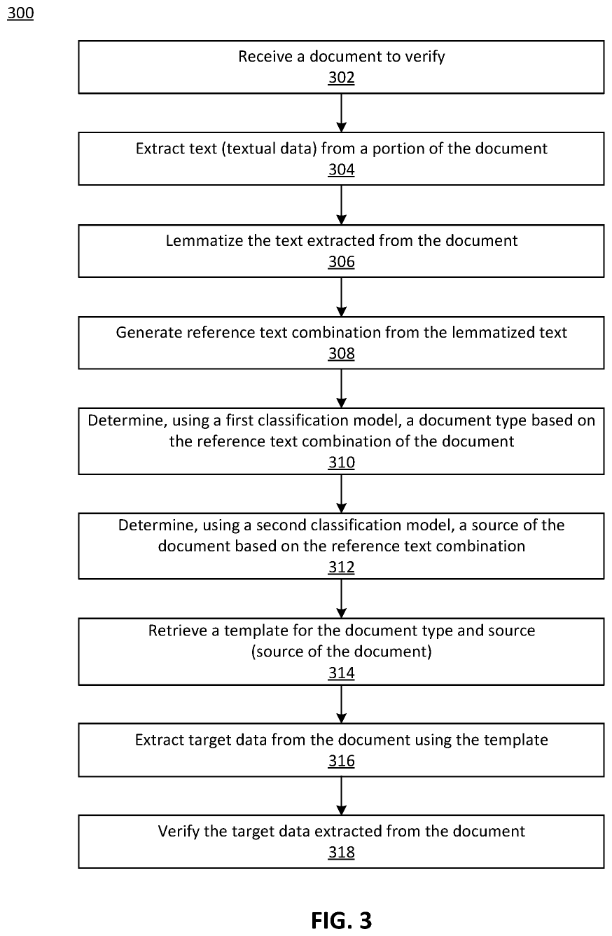

FIG. 3 is a flow diagram of an example process 300 for verifying a document, in accordance with an embodiment of the present disclosure. Process 300 may be implemented, for example, within document verification module 120 of FIG. 1B. In some embodiments, the document verification module may be part of a document verification service (e.g., document verification service 108 of FIG. 1B).

With reference to process 300 of FIG. 3, at 302, a document to verify is received. The document can be received along with a request to verify a document. The request can be received from a document verification service (e.g., document verification service 108 of FIG. 1B). For example, a user associated with an organization can use a client application on their client device (e.g., client device 102 of FIG. 1A) to send a message to the document verification service requesting verification of a document (e.g., a new document received by the organization). In response to such request being received, the document verification service can send a request to the templatization module to verify the document.

At 304, text (e.g., textual data) is extracted from a portion of the document. For example, the text mat be extracted from a header portion or a top portion of a first page of the document. The text can be extracted from the document using techniques such as OCR and computer vision.

At 306, the text extracted from the document is lemmatized. The text can be lemmatized using techniques such as NLU and/or NLP to determine the canonical form of the words in the text. In some embodiments, other data processing, such as tokenization, noise removal, stopwords removal, and stemming, may be performed on the extracted text.

At 308, a reference text combination is generated from the lemmatized text. The reference text combination is a combination of the lemmatized text (e.g., a combination of the known or expected text such as “invoice”, “invoice number”, “purchase”, “purchase order number”, “receipt”, and “receipt date”, among others). The lemmatized text can be analyzed to generate the reference text combination.

At 310, a document type is determined for the document. The document type can be determined based on the reference text combination of the document (e.g., the reference text combination generated at operation 308). A first classification model, such as a multiclass classification model, which is trained on historical documents of the organization can be used to determine (e.g., predict) a document type of the document. For example, a feature vector representing the reference text combination can be generated and input to the first classification model, which outputs a prediction of a document type for the document. In some embodiments, the document verification module can utilize a document type classification engine (e.g., document type classification engine 114 of FIG. 1B) to determine a document type of the document.

At 312, a document source is determined for the document. The document source can be determined based on the reference text combination of the document. A second classification model can be used to determine (e.g., predict) a document source of the document based on the reference text combination of the document. The second classification model may be a classification model that is trained (e.g., configured) to classify documents of a same document type into their document sources. For example, if it is determined that the document is a purchase order, a classification model that is trained to classify purchase orders can be used to determine (e.g., predict) a source of the document. In some embodiments, the document verification module can utilize a document source classification engine (e.g., document source classification engine 116 of FIG. 1B) to determine a document source of the document. In such embodiments, a request to the document source classification engine to classify the document into its document source may include an indication of a document type of the document.

At 314, a template for the determined document type and document source of the document is retrieved. The template may be retrieved from a repository (e.g., data repository 112 of FIG. 1B). For example, if the document is a shipping order from source L, the template for extracting target data from shipping orders from source L can be retrieved.

At 316, target data is extracted from the document using the template. The template indicates the positioning of the target data in the document, thus allowing for extraction of the target data from the document.

At 318, the target data extracted from the document is verified. The target data extracted from the document can be verified by comparing to known value(s). For example, if the extracted target data is a price of the goods in a purchase order, the price can be compared to a known value (e.g., a price that is expected to be in the purchase order) to verify that the purchase order indicates or otherwise has the correct price. The known value may be retrieved from an enterprise system or repository of the organization. In some embodiments, the result of the verification may be sent to a user that requested verification of the document for rendering within a UI of an application on the user's client device (e.g., client device 102 of FIG. 1A), for example.

FIG. 4 is a block diagram illustrating selective components of an example computing device 400 in which various aspects of the disclosure may be implemented, in accordance with an embodiment of the present disclosure. As shown, computing device 400 includes one or more processors 402, a volatile memory 404 (e.g., random access memory (RAM)), a non-volatile memory 406, a user interface (UI) 408, one or more communications interfaces 410, and a communications bus 412.

Non-volatile memory 406 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 408 may include a graphical user interface (GUI) 414 (e.g., a touchscreen, a display, etc.) and one or more input/output (I/O) devices 416 (e.g., a mouse, a keyboard, a microphone, one or more speakers, one or more cameras, one or more biometric scanners, one or more environmental sensors, and one or more accelerometers, etc.).

Non-volatile memory 406 stores an operating system 418, one or more applications 420, and data 422 such that, for example, computer instructions of operating system 418 and/or applications 420 are executed by processor(s) 402 out of volatile memory 404. In one example, computer instructions of operating system 418 and/or applications 420 are executed by processor(s) 402 out of volatile memory 404 to perform all or part of the processes described herein (e.g., processes illustrated and described in reference to FIGS. 1A through 3). In some embodiments, volatile memory 404 may include one or more types of RAM and/or a cache memory that may offer a faster response time than a main memory. Data may be entered using an input device of GUI 414 or received from I/O device(s) 416. Various elements of computing device 400 may communicate via communications bus 412.

The illustrated computing device 400 is shown merely as an illustrative client device or server and may be implemented by any computing or processing environment with any type of machine or set of machines that may have suitable hardware and/or software capable of operating as described herein.

Processor(s) 402 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 402 may be analog, digital or mixed signal. In some embodiments, processor 402 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 410 may include one or more interfaces to enable computing device 400 to access a computer network such as a Local Area Network (LAN), a Wide Area Network (WAN), a Personal Area Network (PAN), or the Internet through a variety of wired and/or wireless connections, including cellular connections.

In described embodiments, computing device 400 may execute an application on behalf of a user of a client device. For example, computing device 400 may execute one or more virtual machines managed by a hypervisor. Each virtual machine may provide an execution session within which applications execute on behalf of a user or a client device, such as a hosted desktop session. Computing device 400 may also execute a terminal services session to provide a hosted desktop environment. Computing device 400 may provide access to a remote computing environment including one or more applications, one or more desktop applications, and one or more desktop sessions in which one or more applications may execute.

In the foregoing detailed description, various features of embodiments are grouped together for the purpose of streamlining the disclosure. This method of disclosure is not to be interpreted as reflecting an intention that the claims require more features than are expressly recited. Rather, inventive aspects may lie in less than all features of each disclosed embodiment.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

Elements of different embodiments described herein may be combined to form other embodiments not specifically set forth above. Other embodiments not specifically described herein are also within the scope of the following claims.

Reference herein to “one embodiment” or “an embodiment” means that a particular feature, structure, or characteristic described in connection with the embodiment can be included in at least one embodiment of the claimed subject matter. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the words “exemplary” and “illustrative” are used herein to mean serving as an example, instance, or illustration. Any aspect or design described herein as “exemplary” or “illustrative” is not necessarily to be construed as preferred or advantageous over other aspects or designs. Rather, use of the words “exemplary” and “illustrative” is intended to present concepts in a concrete fashion.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical examples to aid the reader in understanding the present disclosure, and are to be construed as being without limitation to such specifically recited examples and conditions. Although illustrative embodiments of the present disclosure have been described in detail, various changes, substitutions, and alterations could be made hereto without departing from the scope of the present disclosure. Accordingly, it is intended that the scope of the present disclosure be limited not by this detailed description, but rather by the claims appended hereto.

What is claimed is:

1. A method comprising:
generating, by a document verification service, a reference text combination of a document to verify;
determining, by the document verification service using a first classification model, a type of the document based on the reference text combination of the document;
determining, by the document verification service using a second classification model, a source of the document based on the reference text combination of the document;
determining, by the document verification service, a template for the type of the document and the source of the document, the template indicating positioning of target data in documents of the type and source as the document;
extracting, by the document verification service, one or more target data from the document using the template; and
verifying, by the document verification service, the one or more target data extracted from the document.

2. The method of claim 1, wherein the reference text combination is in a portion of the document.

3. The method of claim 1, wherein the reference text combination is determined from text extracted from a portion of the document.

4. The method of claim 1, wherein verifying the one or more target data includes comparing one of the one or more target data to valid data.

5. The method of claim 1, wherein the first classification model includes a multiclass support vector machine.

6. The method of claim 1, wherein the first classification model is trained using supervised learning with reference text combinations extracted from a portion of each document of a plurality of historical documents.

7. The method of claim 1, wherein the second classification model includes a k-nearest neighbor (k-NN) classifier.

8. The method of claim 7, wherein the k-NN classifier determines the source of the document based on distance measures of the reference text combination of the document and reference text combinations of a plurality of historical documents of the type as the document.

9. The method of claim 1, wherein the template is generated utilizing the first classification model and the second classification model.

10. A system comprising:
one or more non-transitory machine-readable mediums configured to store instructions; and
one or more processors configured to execute the instructions stored on the one or more non-transitory machine-readable mediums, wherein execution of the instructions causes the one or more processors to carry out a process comprising:
generating a reference text combination of a document to verify;
determining, using a first classification model, a type of the document based on the reference text combination of the document;
determining, using a second classification model, a source of the document based on the reference text combination of the document;
determining a template for the type of the document and the source of the document, the template indicating positioning of target data in documents of the type and source as the document;
extracting one or more target data from the document using the template; and
verifying the one or more target data extracted from the document.

11. The system of claim 10, wherein the reference text combination is in a portion of the document.

12. The system of claim 10, wherein the reference text combination is determined from text extracted from a portion of the document.

13. The system of claim 10, wherein verifying the one or more target data includes comparing one of the one or more target data to valid data.

14. The system of claim 10, wherein the first classification model includes a multiclass support vector machine.

15. The system of claim 10, wherein the first classification model is trained using supervised learning with reference text combinations extracted from a portion of each document of a plurality of historical documents.

16. The system of claim 10, wherein the second classification model includes a k-nearest neighbor (k-NN) classifier.

17. The system of claim 16, wherein the k-NN classifier determines the source of the document based on distance measures of the reference text combination of the document and reference text combinations of a plurality of historical documents of the type as the document.

18. The system of claim 10, wherein the template is generated utilizing the first classification model and the second classification model.

19. A non-transitory machine-readable medium encoding instructions that when executed by one or more processors cause a process to be carried out, the process including:
generating a reference text combination of a document to verify;
determining, using a first classification model, a type of the document based on the reference text combination of the document;
determining, using a second classification model, a source of the document based on the reference text combination of the document;
determining a template for the type of the document and the source of the document, the template indicating positioning of target data in documents of the type and source as the document;
extracting one or more target data from the document using the template; and
verifying the one or more target data extracted from the document by comparing one of the one or more target data to valid data.

20. The machine-readable medium of claim 19, wherein the template is generated utilizing the first classification model and the second classification model.
